(19) United States
(12) Patent Application Publication
(10) Pub. No.: US 2021/0365500 A1
(43) Pub. Date: Nov. 25, 2021

(54) SYSTEM AND METHOD FOR QUESTION-BASED CONTENT ANSWERING

(71) Applicant: Miso Technologies Inc., San Francisco, CA (US)

(72) Inventors: Lasantha Lucky Gunaselara, Cambridge, MA (US); Cheng-Kang Hsieh, Mountain View, CA (US); Chih-Ming Chen, New Taipei City (TW); Chen-Hung Pai, Hsinchu City (TW)

(21) Appl. No.: 17/324,938

(22) Filed: May 19, 2021

Related U.S. Application Data
(60) Provisional application No. 63/027,233, filed on May 19, 2020.

(51) Int. Cl. G06F 16/9032; G06F 16/9535; G06F 16/951; G06N 3/08

(52) U.S. Cl. CPC G06F 16/90332; G06N 3/08; G06F 16/951; G06F 16/9535

(57) ABSTRACT

A system and method for question-based content answering that can include training a query-content model; indexing a collection of media content data forming indexed content; receiving a query input through a computer implemented computer interface; applying a retrieval model to the query input and indexed content and determining candidate content segment results, which may include: retrieving an initial set of candidate content segments by performing a keyword search of the query input on the indexed content, and ranking, based in part on language modeling using the query-content model, the initial set of candidate content segments into the candidate content segment results; and presenting the candidate content segment results in the computer interface.

### CROSS-REFERENCE TO RELATED APPLICATIONS

This application claims the benefit of U.S. Provisional application No. 63/027,233, filed on 19 May 2020, which is incorporated in its entirety by this reference.

### TECHNICAL FIELD

This invention relates generally to the field of search engines, and more specifically to a new and useful system and method for question-based content answering.

### BACKGROUND

There have been tremendous amounts of research in natural language understanding and search engine technology. With respect to the internet there are many techniques used in applying robust query and public signals for determining relevance of content for a query. However, these techniques are less useful for content for which robust context signals in the query do not exist or the amount of historical data and usage is too low to apply to try and determine context. As such, many search and discovery systems rely on basic search algorithms based on simple keyword searching and other basic approaches. For example, standard search models have been refined for searching webpages but generally do not work as well when searching within digital media such as digital books, articles, videos, or audio.

Personalization of content is also something that many large-scale internet companies are able to offer in their products because of the amount of data they have from all the users using their products. Often, personalization depends on having large amounts of data on how a particular user and/or segment of similar users respond to content. The approaches used in these large-scale products similarly fail to translate to applications that have much smaller user bases, relative content collections and historical data to learn from. Even with large scale systems, it can be complicated to implement high-quality search engines that balance equally precision and recall for each individual user.

With such limitations, many search engine implementations are limited in their sophistication. In particular, implementations of question-answer query systems are commonly rudimentary in their approach. As a result, users are not provided the type of experience they would expect from other forms of search. For instance, when a user makes a question-answer query, they are not just looking for a document that's relevant to the query—they are looking for a specific sentence or paragraph fragment containing an answer that answers the question in the query. However, most traditional search engines aren't able to parse their document index and the queries themselves to find these robust answer candidates, let alone in the relative personalized context of each user. This makes such query systems frustrating to use, and furthermore limits the usage by users of such systems.

Thus, there is a need in the search engine field to create a new and useful method for question-answer search capabilities in a search engine with the complementary relevance ranking of answer candidates. This invention provides such a new and useful system and method.

### BRIEF DESCRIPTION OF THE FIGURES

FIG. 1 is a flowchart representation of a first method.

FIG. 2 is a flowchart representation of one variation of a method.

FIG. 3 is a flowchart representation of one variation of a method employing the use of a bidirectional encoder representations from transformers (BERT) language mode.

FIG. 4 is a flowchart representation of one variation of a method that uses provided and/or accessible models and indexed content.

FIG. 5 is a schematic representation of using a BERT language model.

FIG. 6 is a schematic representation of parsing, segmenting, and indexing an exemplary markup text document content segment.

FIG. 7 is a schematic representation of one exemplary ranking process that uses a query-content model.

FIG. 8 is a schematic representation of one exemplary ranking process that uses a query-content model and keyword scores.

FIG. 9 is a schematic representation of one exemplary ranking process that uses a query-content model, keyword scores, and user affinity scores.

FIG. 10 is a schematic representation of one exemplary ranking process that uses a query-content model, keyword scores, and supplemental signals.

FIG. 11 is a schematic representation of using a CML to generate user affinity scores for content segments.

FIG. 12 is a schematic representation of a variation of using a CML to generate user affinity scores based on context keywords of content segments.

FIG. 13 is a flowchart representation of conditionally using explicit context keywords or using user affinity scores for implied context.

FIG. 14 is a flowchart representation of conditionally using explicit context keywords.

FIG. 15 is a flowchart representation of a variation of a retrieval model method.

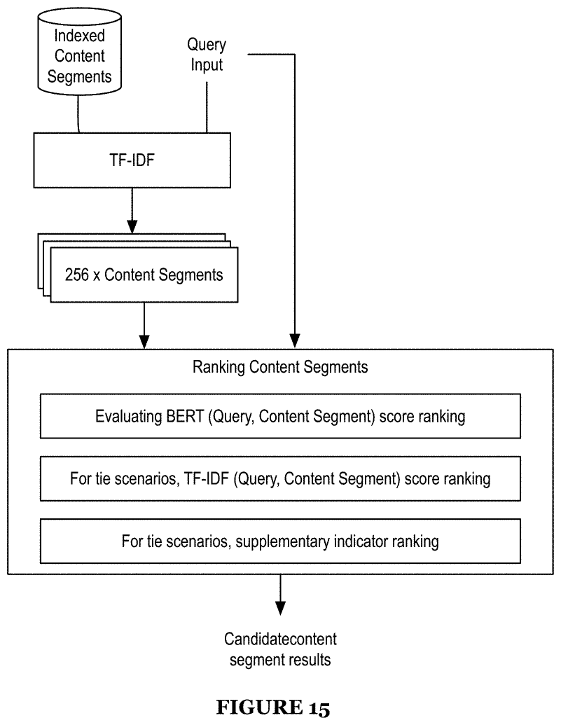

FIG. 16 is a flowchart representation of a variation of a retrieval model method.

FIG. 17 is a schematic representation of a query interface.

FIG. 18 is a schematic representation of a system.

FIG. 19 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A method and system for question-based answering leverages deep semantic understanding of content, using a trained language model, for search and prioritization of content. The method and system can preferably be used in translating and parsing a collection of long-form media and content into shorter digestible content segments to serve as the sources for candidate responses for an input query, in the form of a question. For example, a large collection of electronic/digital books on one or more academic or technical subjects can be processed by the method and system, such that a user could submit a question as input into the computer-implemented system and then the relevant paragraphs/sections from a variety of appropriate books could be delivered as possible solutions or answer candidates to the question. The system and method may be applied to a wide variety of ways.

The system and method are preferably implemented in connection with a query interface for searching a collection of information, like the input fields typical of most search engines. Once supplied, a query input in the form of a question is used by the system and method to identify relevant content segments from the collection of indexed information that may potentially address the query. In one preferred variation, the search process combines keyword search model, a language model, and context affinity ranking in generating a list of relevant content segments, potentially containing answer spans.

The system and method in one variation are configured for supplying content containing answers, solutions, and/or other forms of relevant information for a query input that is phrased as a question. The system and method may additionally or alternatively work for a general search query, which may be a collection of relevant words or phrases. In another variation, the query input may be phrased or supplied in a different format. In some variations, the query input may be extracted from a digital system. For example, a form cataloging a patient's current conditions may be used in fetching relevant content that may be helpful for a healthcare worker.

The system and method preferably use a trained language model within the search process so that content is selected based on a modeled understanding of semantic relevance between a query and the target content to address the query.

The system and method may additionally be contextual in nature, where various contextual cues can be used in customizing the results. In some variations, this may be manifested as personalized search and relevancy ranking of answer candidates for a user. As a user uses a system, the interests and attributes of a user may be automatically used in contextually prioritizing answer candidates sourced from the content index. This may use a user/context affinity model or through determination of contextual indicators from other sources.

The system and method, in one preferred application, may be used in allowing a question-centric queryable interface to a large collection of information. In particular, the system and method have use where the information was originally intended for an alternative form of consumption. Long-form media content such as books, manuals, research papers, documentation (e.g., a company's internal information database), and/or other general information content can be indexed and processed into a segmented format to address specific queries. Long-form media content can include text-based documents and media content, but may additionally or alternatively include other forms of long-form media such as media recordings like video and/or audio content.

The system and method are preferably used in delivering segments of media content that specifically address a query input. For example, when searching across a large library of books (e.g., thousands of books), the system and method can be used in returning a specific segment of one book based on the query input.

In one exemplary implementation, the system and method may be used to make a large number of technical references and books queryable for specific applied questions. With a sufficiently large corpus of engineering, programming, and scientific references processed, the system and method may be used in offering a valuable question-answer interface for technical questions. For example, a query for “how to sort a list” will preferably return relevant sections from a number of computer programming reference texts that specifically address this question. Furthermore, if the query is updated with more specific context like “how to sort a list in python” the results will similarly be updated to present relevant sections in computer programming reference texts for how to sort a list in Python. In a similar manner, if the user has previously indicated affinity to python-related content such context may be automatically integrated into the prioritization of search results and the results may indicate relevant sections for sorting a list in Python, without the user having to explicitly state python in the query.

In another exemplary implementation, the system and method may be used in the medical space. Similar to above, medical texts, research paper, drug informational sheets, and/or other content can be used by the system and method to deliver relevant solutions for a given question. Furthermore, the ability of the system and method to incorporate contextual signals into the results can be used when a healthcare worker (or other user) is pursuing a particular line of queries. For example, a query can generate context used in subsequent queries. Additionally, a medical-based implementation may integrate with other data sources. For example, a subject's health data may be accessed with proper privacy and security mechanisms and used in generating context. In this way, a user may not need to specify the gender, age range, pre-existing conditions, allergies, current medications, and/or other details. These contextual cues would be automatically applied and used in prioritizing query results.

In another exemplary implementation, the system and method may be used to enhance customer service. Resources for customer service agents such as FAQ documents, internal information resources, forum content, and the like may be compiled and used to help a customer service agent answer questions and solve customer issues. The personalization can be scoped and applied for each session or customer. Context information about a customer such as the model number of the product having issues can be automatically applied and used as it makes sense for finding relevant results to given queries. In one implementation, the system and method may be implemented with system integration with a customer database so as to automatically collect data for a particular user such as accessing order information. Then successive queries and collection of user and/or context-related information (e.g., technical problems they are having) can be used in personalizing content queries in real-time. In some variations, this may be automatically enabled in connection with the communication through which a customer service agent is communicating with a customer. For example, a customer profile may be generated or accessed based on a communication identifier of a customer (e.g., the customer's phone number or email address).

Herein, reference to content refers to digital data files of various forms of content/media. Text-based documents are one example of the type of media content that can be searched using the system and method. The system and method may additionally or alternatively be used with other forms of content such as temporal media recording data files like video and/or audio content. Video and/or audio content can be segmented and analyzed to convert the videos or audio into content segments. Transcripts, speech to text conversion, image analysis, and/or other aspects may be used when processing media recording data files like video and/or audio.

While the system and method are primarily described as being applied to question-answer query interactions, the system and method may alternatively be modified for other uses. As one example, the system and method may be modified for providing statement/fact verification. For example, instead of a question, a statement or supposed fact may be submitted as input. The system and method can then identify content segment from various sources that correspond to that statement. They may either support that fact (wherein a matching process can measure the degree to which the statement corresponds) or may alternatively supply related information that may contradict or otherwise be relevant to that statement.

The implementations of the system and method are used as examples and do not limit the system and method to being used in other applications. The system and method may have particular utility for adding a search interface for querying specialized knowledge bases for domain-specific problem solving. However, the system and method may be used to enable search interface on any suitable collection of information.

The system and method may provide a number of potential benefits. The system and method are not limited to always providing such benefits, and are presented only as exemplary representations for how the system and method may be put to use. The list of benefits is not intended to be exhaustive and other benefits may additionally or alternatively exist.

As one potential benefit, the system and method can be used for making a wide variety of types of content retrievable through a query interface. The system and method can preferably be used for content without needing to have collected a lot of prior data and specific machine learning for that content. This can make the system and method particularly useful for domain-specific information collections where pre-existing data for that collection of information may not exist and the application itself is resource-scarce when it comes to the limited potential for machine learning.

As another potential benefit, the system and method can translate content intended for other forms of consumption into a solution-based content. For example, a large collection of books that were written by various authors and intended for in-depth consumption may be translated by the system and method, wherein segments from the books can be delivered as relevant answer results to different question queries.

The system and method preferably enable the querying of results that automatically contextualizes the query beyond explicit query input. This may be used in delivering highly personalized content results. In one implementation, this contextualization can be delivered using collaborative metric learning (CML) based personalization of content. For example, a person who has a profile associated with a particular programming language such as JavaScript may have that personalized context integrated into the querying and sorting of results for a query like “how to sort an array”. The results will automatically show results prioritized by their relevance to a modeled understanding of the user.

As a similar potential benefit, the system and method may be configured for highly reactive querying, wherein a series of queries are customized to that particular scope of queries. This may be used in a customer care situation where an agent is using the query tool to find possible solutions, where the result content is customized to the line of questions. For example, a sequence of related but different queries may build up contextual model of the scenario and be used in retrieving and/or prioritizing subsequent results.

### 2. Method

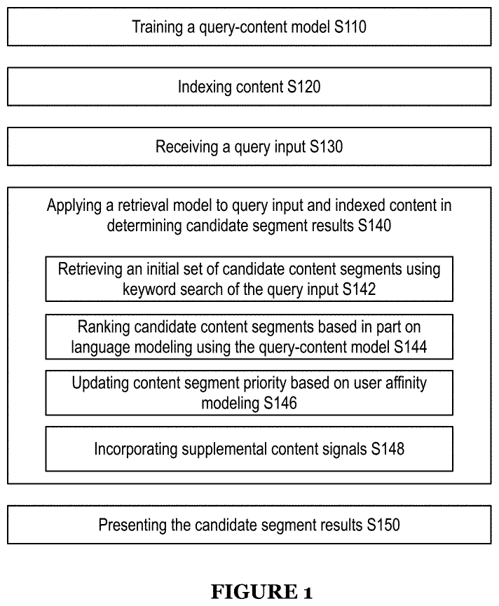

As shown in FIG. 1, a method for question-based content searching of a preferred embodiment can include training a query-content model S110, indexing content S120, receiving a query input S130, applying a retrieval model to query input and indexed content in determining candidate content segment results S140, and presenting the candidate content segment results S150.

Applying a retrieval model S140 may include retrieving an initial set of candidate content segments using keyword search of the query input S142 and ranking candidate content segments based in part on language modeling using the query-content model S144. Applying a retrieval model 140 may further include updating content segment priority based on user affinity modeling S146 and/or incorporating supplemental content signals S148. Scores from the keyword search process may additionally be used in ranking the content segments.

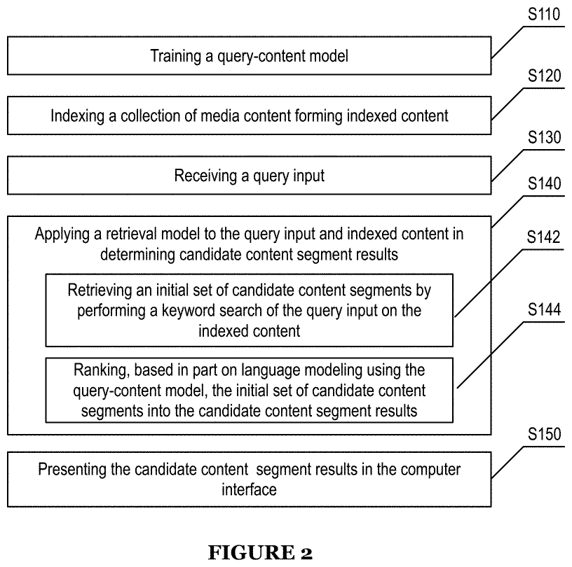

In one exemplary implementation the method, as shown in FIG. 2, may include training a query content model (S110); indexing a collection of media content forming indexed content (e.g., S120); receiving a query input (S130), applying a retrieval model to the query input and indexed content in determining candidate content segment results (S140), which comprises: retrieving an initial set of candidate content segments by performing a keyword search of the query input on the indexed content (S142), and ranking, based in part on language modeling using the query-content model, the initial set of candidate content segments into the candidate content segment results (S144); and presenting the candidate content segment results in the computer interface (S150).

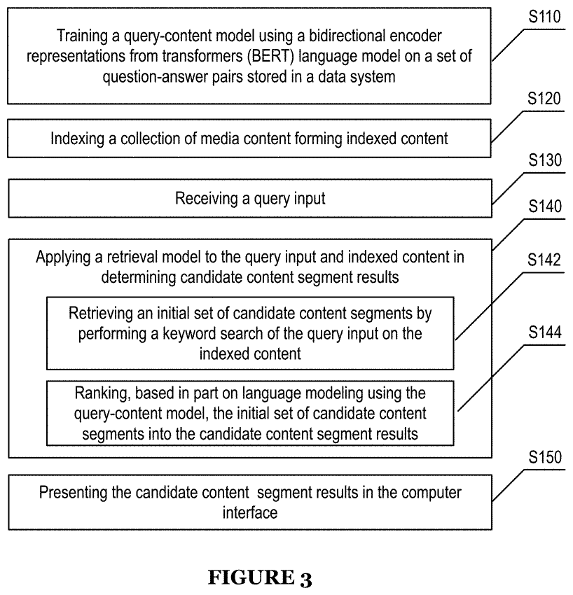

As an exemplary implementation leveraging a bidirectional encoder representations from transformers (BERT) language model or alternative language model, the method may be implemented, as shown in FIG. 3, by training a query-content model using a bidirectional encoder representations from transformers (BERT) language model on a set of question-answer pairs stored in a data system (S110); indexing a collection of media content forming indexed content (e.g., S120); receiving a query input (S130), applying a retrieval model to the query input and indexed content in determining candidate content segment results (S140), which comprises: retrieving an initial set of candidate content segments by performing a keyword search of the query input on the indexed content (S142), and calculating a query-content model score for each content segment of the initial set of candidate content segments and ranking the initial set of candidate content segments by the query-content model score (S144); and presenting the candidate content segment results in the computer interface (S150).

In an additional variation of the above implementations, ranking, based in part on language modeling using the query-content model, the initial set of candidate content segments into the candidate content segment results may include: for each subset of query-content model scores satisfying a tie scenario condition, ordering content segment results of each subset of by a keyword search score. For example, if after ordering an initial list of candidate content segments by BERT scores there are some with scores within some defined tie-condition threshold, then a TF-IDF score may be used to order content segments with “tied” BERT scores. Further tie-breaking may additionally or alternatively be used using other parameters such as user affinity scores, content external signals (e.g., source material quality scores, etc.)

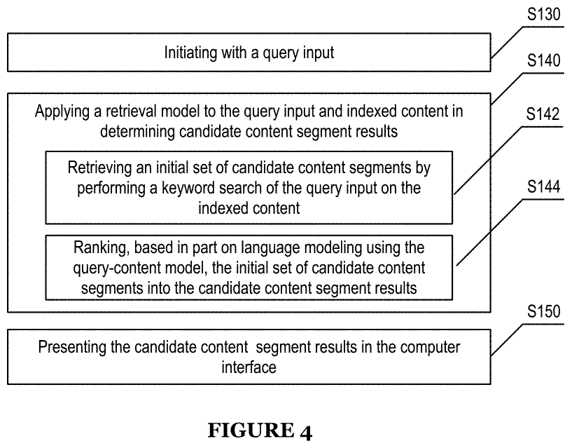

In some variations, the method may be implemented with pre-trained models and/or prepared data systems. As such some implementations of the method, as shown in FIG. 4, may alternatively include: initiating the method with a query input (e.g., by receiving a query input S130); retrieving an initial set of candidate content segments using keyword search of the query input S142 and ranking candidate content segments based in part on language modeling using the query-content model S144 (e.g., as part of applying a retrieval model to the query input and indexed content in determining candidate content segment results); and presenting the candidate content segment results in a computer interface S150. This method may involve accessing or otherwise interfacing with a query-content model and/or indexed content data system (e.g., a digitally indexed collection of media content data).

The method is preferably implemented in connection with a computer system such as the one described herein. the computer system is specially configured and through implementation of the method is able to provide significantly more relevant results with performance outpacing prior implementations.

In one variation, a non-transitory computer-readable medium storing instructions that, when executed by one or more computer processors of a computing platform, cause the computing platform to perform the operations of a method variation described herein such as: training a query-content model; indexing a collection of media content data forming indexed content; receiving a query input through a computer implemented computer interface; applying a retrieval model to the query input and indexed content and determining candidate content segment results, which comprises: retrieving an initial set of candidate content segments by performing a keyword search of the query input on the indexed content, and ranking, based in part on language modeling using the query-content model, the initial set of candidate content segments into the candidate content segment results; and presenting the candidate content segment results in the computer interface.

In another variation, a system comprising one or more computer-readable mediums storing instructions that, when executed by the one or more computer processors, cause a computing platform to perform operations of a method variation described herein such as: training a query-content model; indexing a collection of media content data forming indexed content; receiving a query input through a computer implemented computer interface; applying a retrieval model to the query input and indexed content and determining candidate content segment results, which comprises: retrieving an initial set of candidate content segments by performing a keyword search of the query input on the indexed content, and ranking, based in part on language modeling using the query-content model, the initial set of candidate content segments into the candidate content segment results; and presenting the candidate content segment results in the computer interface.

The method may be implemented in various forms such as for question-answer search of technical resources (e.g., books and papers), customer service, fact-checking/source discovery, and/or other suitable applications. The system may be implemented by the system(s) described herein, but may alternatively be implemented by any suitable system.

Block S110, which includes training a query-content model, functions to generate a language model that signals if and the degree to which content is semantically compatible with a query. In particular, block S110 is used in training a language model on evaluating relevance of question-answer pairs. Block S110 is preferably used in generating a language model relevant to a specific domain-specific topic. For example, a query-content model may be generated for one or more topics related to science, engineering, programming, medical, and the like.

Training a query-content model preferably includes initiating the query-content model with a pre-trained language model and updating the pre-trained language model with at least one domain-specific data set. This functions to leverage large-scale and general language models to accelerate language modeling but then refining the model for evaluation of a particular topic.

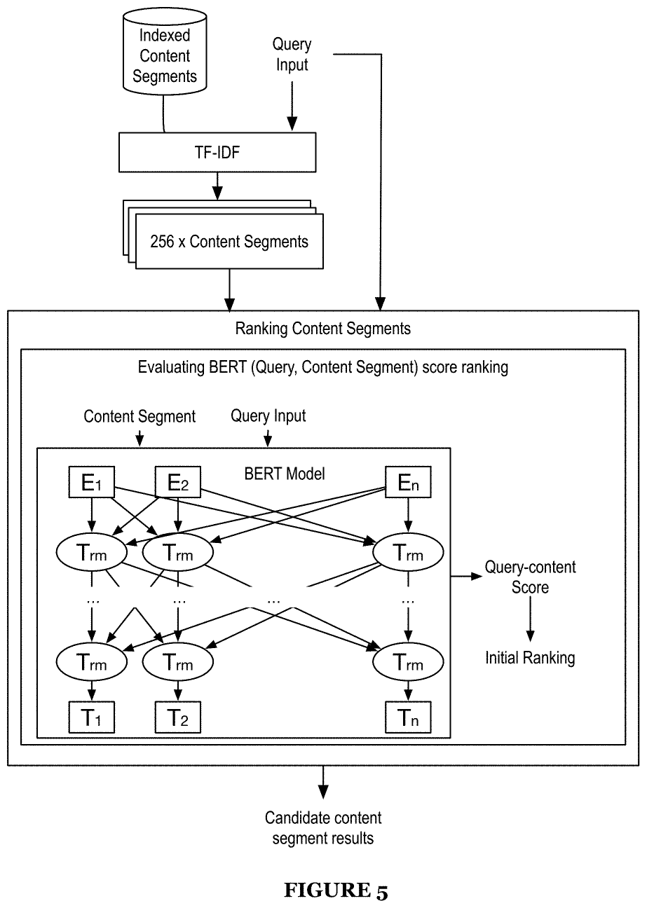

In one variation for a technical question answer implementation, training the query-content model includes using a BERT (Bidirectional Encoder Representations from Transformers) language model and updating training of the BERT language model with a set of question-answer pairs. The BERT language model can be a deep learning model with a model architecture that includes number of layers (transformers), a number of attention heads, and a number of parameters as shown in FIG. 5 (where E nodes represents embedding representation from an embedding layer, Trm are intermediate representations, and T are final output). For example, there may be 12 layers, 12 attention heads and 110 million parameters. Other suitable number of layers and attention heads may be used. Generally, the language model can include over a million parameters (e.g., greater than 100 million) but different models may have different architecture properties. Other pre-trained language models may alternatively be used. The question-answer pairs may be obtained from an external source such as a technical question-answer website. The resulting query-content model measures the semantic compatibility between a given query and a selection of content.

Herein, BERT is used as one exemplary language model that may be used but the method may be adapted and/or performed using an alternative language model. In some variations, the language model is a transformer-based language model such as BERT. Other Alternatives could include examples such as alternative versions of BERT language model; Generative Pre-trained Transformer (GPT), GPT-2, GPT-3, and similar language models; XLNet; Text-to-Text Transfer Transformer (T5); and/or other models.

In some alternative implementations, the method may be implemented by accessing or interfacing with a pre-trained language model. In this variation, no active training of the model may be performed, but the model may be leveraged and used in subsequent processes of the method.

Block S120, which includes indexing content, functions to onboard a set of resources that will act as a source of content that can be used to resolve a query. Generally, indexing content is performed by indexing a collection of media content data which forms or establishes indexed content. The indexed content then can serve as the subject for subsequent queries and information retrieval.

Indexing content may be a one-time operation. Alternatively, indexing content may include indexing an initial set of content and then indexing new content as it's received. In this way, the method may be used on a changing corpus of information. Indexing of content is preferably performed prior to serving a query input.

By way of example, indexing content may include a publisher, library, or other holder of a large number of books, articles, or text content to index a large number of the content. In another example, a customer support service may index a number of documents and content related to internal documentation for servicing customers such that customer support agents can better query and find relevant information to help customers when communicating with customers.

The content can be in a variety of formats. Example formats of content can include books, papers, documents, and/or websites. The original content format may alternatively be any suitable type of format. The content is generally described as text and/or multi-media text documents. The content may alternatively be any suitable medium. For example, audio and/or video content may have transcriptions indexed, and/or content automatically translated to a textual description so that search can be applied to the non-text media.

Indexing content may include parsing and segmenting content, which functions to translate original content into content segments or textual spans that can be used as responses to a given query. In one exemplary implementation, indexing the collection of media content data can include parsing and segmenting the text-based documents into paragraph content segments (e.g., or other suitable textual spans/segments) with context data that includes document title, document description, section headers (chapter titles, subsection headers, etc.), and/or adjacent paragraphs.

Different approaches may be used for different forms of content.

Parsing and segmenting book, article, web, or other forms of text-based content may segment a piece of content into multiple content segments by dividing paragraphs, sections of a document, chapters, or other partitions of the text-based content. In some variations, paragraphs may be grouped based on topic relevance so that 2-3 paragraphs addressing one general topic may be detected and grouped as one content segment.

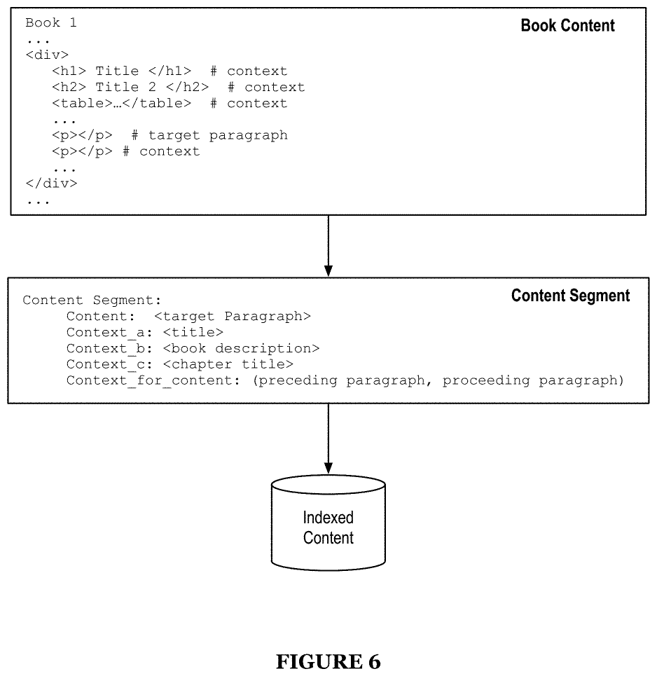

As one example, the content may be text content formatted in a markup language such as HTML, XML, markdown, or other digital document encoding document content and formatting. In the case of HTML and XML, the DOM may be processed so as to extract content from content-related tags (e.g., <p> tags) and using heading tags or other context related tags as context of child content elements. As shown in FIG. 6, DOM tags may be processed to establish content and context defining different content segments.

Parsing and segmenting recorded media such as video and/or audio content may include analyzing and dynamically segmenting the recorded media. In the case of video, parsing and segmenting may include performing segment classification on audio content of the video.

In one example, parsing and segmenting may include transcribing audio into a text-based transcription of the audio content. Alternatively, a transcription may be accessed if available. The transcription is preferably time-mapped. Parsing and segmenting can then include segmenting the audio based on the transcription. This may include performing topic classification and determining contextually-associated windows of the transcript and setting those windows as content segments. Additionally or alternatively, this may include content segments based on pauses or detected breaks in the audio. Such audio and/or transcription analysis can similarly be used in video content that includes audio content.

Additionally or alternatively, parsing and segmenting video content may include performing visual classifications of segments. Visual classification may use various computer vision classification processes to automatically classify windows of content as content segments.

In the case of an audio and/or video content, text-based transcription or other text-based descriptions of the content may be or form the indexed content. It is preferably indexed with reference to the associated recorded media content. In this way, a query can be used to determine which segment of audio or video content relates, and then that segment can be retrieved and/or presented. Accordingly, indexing content can include indexing transcript segments of recorded media, wherein the transcripts segments map to recorded media segments. In an example where content includes presentations, the text and/or content visually communicated in the video content can be visually detected and extracted and then indexed and/or used in segmenting recorded media content.

Parsing and segmenting may additionally generate multiple overlapping content segments of varying “window” sizes. These different content segment windows may enable different scopes of a piece of content to be evaluated and then presented depending on how much of a piece of content may be relevant. For example, one section of a book that is made up of three paragraphs may be segmented into a first content segment of the entire section, and three additional content segments (one for each paragraph). This segmentation of varying scope may be used to deliver content segments of the correct size depending on if the whole section or an individual paragraph has higher relevance. Other approaches may alternatively be used in determining the scope of a content segment when applying a retrieval model in block S140.

While parsing and segmenting content, indexing content S120 may include annotating content segments with associated metadata. For example, book titles, book summaries, chapter titles, section titles, chapter/section summaries, figure captions, webpage breadcrumbs, category or topic tags, comments, and/or other periphery data may be stored as data associated with a given content segment. In particular, these anchor markers or breadcrumbs can reveal a lot as “parent” units about the child segments or spans of text below.

Additionally, associated metadata may include adjacent content segments. For example, a collection of books may be indexed by indexing each paragraph of the collection of the books. For each paragraph, metadata related to book information (e.g., title, topic, classification, summary, author, etc.), chapter information (chapter title, keyword summary), subsection information, and the content of the proceeding and proceeding paragraphs may be used as metadata. In some instances, the metadata may be direct extraction of text information such as a book title or chapter title. In some instances, one or more portions of the metadata may be extracted metadata based one automated analysis. For example, text analysis of a chapter may be used in generating a topic summary, a list of top keywords, and/or other analysis results.

Indexing content may additionally include collecting various content signals such as click/read/view count, upvote count, comments, sharing information, citations (e.g., peer review citation count), social media metrics or signals, search-like scoring (e.g., Page Rank), and/or other data metrics that may be used in evaluating the interest, quality or relevance of a given piece of content. These content segments may be stored and used when applying the retrieval model. In some variations, similarly ranking content segments may be differentially reranked based, in part, by such content signals. For example, during block S140, two similarly segments from different books may be reranked according to the number of citations or other signals related to the “value” of the books.

Block S130, which includes receiving a query input, functions to obtain at least one query input. Receiving the query input is received through a computer-implemented computer interface. In a preferred implementation, a user interface is provided through which a user can supply the query input. For example, a webpage or application accessible through a client device (e.g., a browser on a computer, smart phone, or other computing device) can provide a text input field through which a text-based query can be entered and then submitted. While a text-based input field is one option, the method is not limited to a text input field. In another variation, a voice-based input interface may be used. In this variation, receiving a query input includes receiving a voice-based query through a voice computer interface. For example, a user may make voice query to an audio-based assistant.

In another variation, the query input may be supplied not through a single user-supplied query. The query input may be compiled from a plurality of sources. Examples of other data sources that may be used to generate a query input can include, the current state of an application (e.g., what content is being viewed by a user within an application), responses to one or more form inputs, historical records on previous activity. In one example, a user may be able to highlight a portion of a digital document and a list of relevant content segments relevant to the highlighted content can be fetched and presented. In another example, a query input may be generated based on a number of medical related prompts related to a patient's state.

In other implementations, the query input may be obtained or supplied through a programmatic interface such as an application programming interface (API). In this variation, an API request can be supplied along with one or more parameters that can be used in forming the query input. In one variation, the query input may not be explicitly entered by a user but may be obtained from another digital service.

For example, a customer service tool may automatically translate a verbal description of the issue of a customer into a list of content segments and resources that address the issue, which may be displayed to a customer service agent that is assisting a customer or, in a self-service variation, may be presented directly to the customer.

In another example, a medical information system may extract case data for a particular patient and translate that into an automatically generated query used to provide useful information to a healthcare worker.

In another example, a software development IDE (integrated development environment) may translate the current context of the IDE into a list of relevant content suggestions. For example, the current line of code and associated code may be used in displaying helpful information in real-time, where the content may be updated based on changing context of the code.

Block S140, which includes applying a retrieval model on the query input and indexed content in determining candidate content segment results, functions to process the query input using a processing pipeline so as to identify and select a relevant set of candidate content segments that correspond to the query input. The candidate content segment results may further be determined and selected based on context and personalization. The retrieval model may use a variety of techniques across identified content segments to narrow the set of content segments for analysis and then prioritizing those content segments. When content segments have variable size (e.g., the number of paragraphs), the retrieval model may additionally be used in determining individual content segment selection, where the selection can determine the scope or size of the content segment to present.

The candidate content segment results preferably include or references relevant content segments and prioritizes or scores each of the relevant content segments, where the score is associated with a measure of how well the content segment relates to the query input. In some cases, a prioritized list of content segments may be the result. In some cases, the single (or other suitable number) of results can be identified as the result. The retrieval model is preferably used in identifying, narrowing, and prioritizing content segments so as to form the candidate content segment result(s).

Applying a retrieval model on the query input and indexed content preferably involves the combined application of term-based search to establish a base set of potential results and then use a transformer-based language model in sorting the base set of results. Accordingly, applying a retrieval model S140 may include retrieving an initial set of candidate content segments using keyword search of the query input S142 and ranking candidate content segments based in part on language modeling using the query-content model S144.

Ranking of candidate content segments may further be refined using various approaches to differentiating closely ranked content segments. Accordingly, applying a retrieval model 140 may further update content segment priority based on user affinity modeling S146 and/or incorporating supplemental content signals S148. The processes applied may depend on a variety of conditions and may be used in determining prioritization of sub-groups of a list of possible content segments.

For each subset of query-content model scores satisfying a tie-scenario condition, ordering content segment results of each subset of by at least one of a keyword search score, a user affinity modeling score, a metadata related score, and/or other suitable scoring metrics. Multiple tiers of tie-breaking may be used with different thresholds. The order and configuration of how ranking is performed may be based on the objectives of the particular implementation. For example, one implementation may prioritize social-signals indicating value of content sources and therefore use social-signals like a source score (e.g., based on citations, publication ranking, share count, etc.) while another implementation may prioritize user personalization where a user affinity modeling score is used as an earlier tie-breaking process.

Block S142, which includes retrieving an initial set of candidate content segments using keyword search of the query input, functions to quickly narrow the list of content segments for processing. Block S142 can use a variety of searching techniques. In one variation, TF-IDF (term frequency-inverse document frequency) processing is used. Accordingly, retrieving an initial set of candidate content segments using keyword search of the query input comprises performing term frequency-inverse document frequency processing when retrieving the initial set of candidate content segments. A TF-IDF weighting scheme can be used in scoring and ranking relevance of the indexed content segments for a given query. The TF-IDF model (e.g., a vector space model) can preferably perform fast keyword-based search and retrieval across the indexed content. Retrieving the initial set of candidate content segments is preferably used to identify a small pool of content segments that can then be prioritized through subsequent processing of the retrieval model. In one variation, a TF-IDF model is used in identifying 256 content segments as the initial set of candidate content segments. However, any suitable number may be identified.

As discussed above, some content segments may be indexed in association with supplementary information such as book/chapter/section titles, book/chapter/section summaries, category, and topic tags, and/or other information. Keyword search can preferably search against the content segments in combination with their supplementary information.

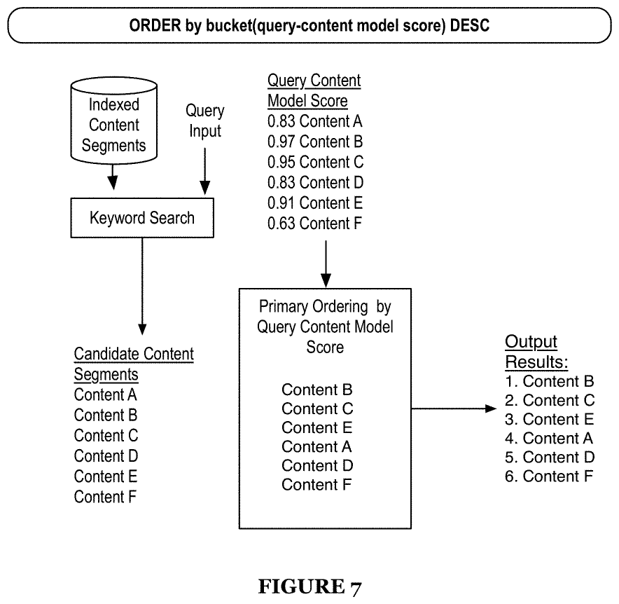

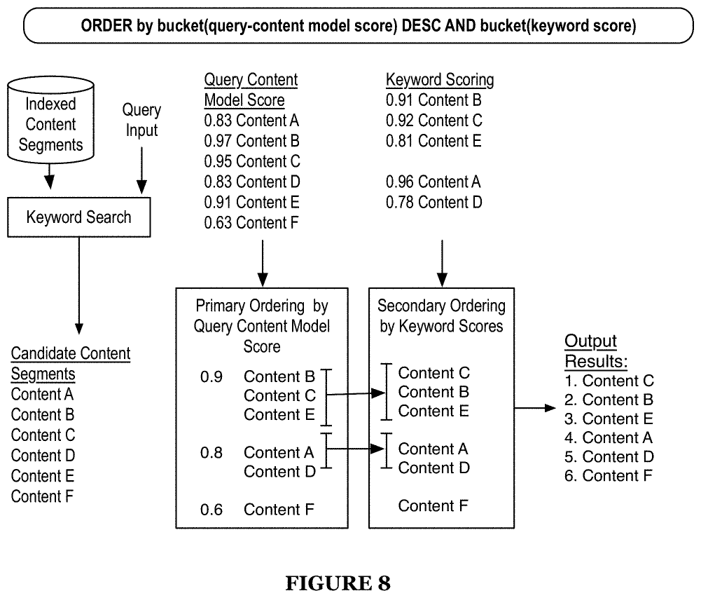

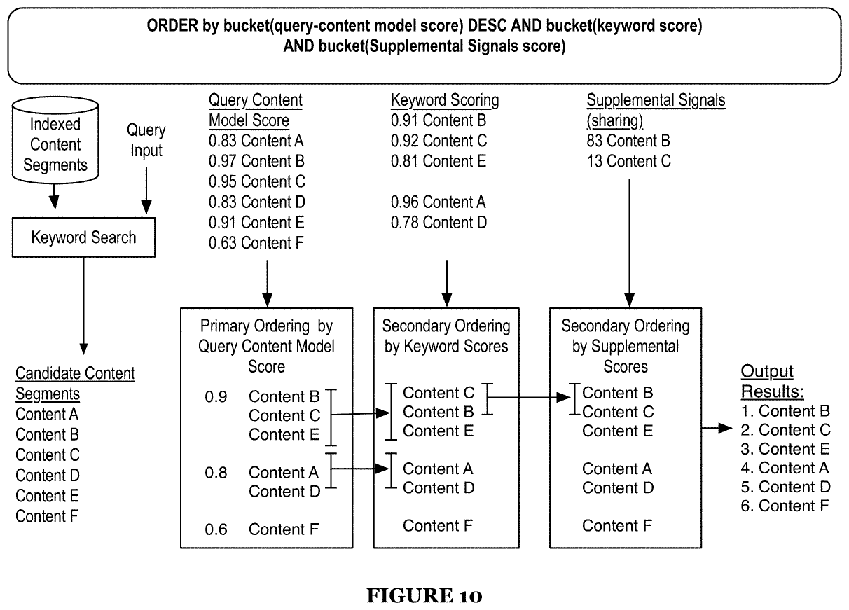

Block S144, which includes ranking candidate content segments based in part on language modeling using the query-content model, functions to refine the initial set of candidate content segments. The score yielded by the query-content model preferably indicates the probability of how well a particular content segment satisfies the query input. The query content model is preferably applied to score the pairing of the query input and a given candidate content segment. A resulting query-content model score can then be used to rank at a least a subset of the candidate content segments. As shown in FIGS. 7-10, there the ranking may be based on the query-content model score in a variety of ways. For example, a BERT model score may be generated for the pairing of the query input and a content segment. This ranking is used in the formation of the candidate content segment results. In a first variation, the query-content model score is used in establishing a primary ranking of content segments. In some variations, that may be the resulting prioritization ranking as shown in FIG. 7. In some variations, such as shown in FIGS. 8-10, secondary ranking properties may be used to disambiguate between similarly scored content segments.

The query-content model may be used in scoring each content segment in the initial set of candidate content segments. Accordingly, ranking candidate content segments based in part on the language modeling using the query-content model can include: calculating a query-content model score of the query input for each content segment in the initial set of candidate content segments (e.g., those identified using keyword search) and ranking the initial set of candidate content segments by query-content model scores. The result of this process is ordering using the language model for results that were initially selected using a base search process like keyword search. In some cases, a ranked list of candidate content segments (ranked by query-content model scores) may then be selected based on rank if the number of results is configured to be less than the initial set of candidate content segments.

Alternatively, the query-content model may be used to score only a subset of the candidate content segments and/or for content segments meeting some condition. In some variations, the query-content model may be used as a secondary ranking property used for tie-breaking conditions of initially ranked content segments. For example, the query-content model may be used when the keyword search scores for a group of candidate content segments are the same or substantially the same. In this way process S144 may include calculating a query-content model score of the query input for a subset of content segments in the initial set of candidate content segments (e.g., those identified using keyword search) and ranking the subset of candidate content segments based on the query-content model scores. In some cases, the ranking may be exclusively based on the query-content model scores, but other factors may alternatively or additionally be used.

In some variations, the pre-trained language model may additionally handle semantic disambiguation when running the query. The terms supplied in the query input can be expanded to other suitable synonymous terms using the language model. For example, for a query such as “What is the best vaccine candidate for COVID-19?”, the language model can extrapolate so that the query is evaluated similarly or equivalent to semantically similar or identical queries such as “What are the best (acquired immunity) vaccines for 2019-nCoV/SARS-CoV-2/COVID-19/ the novel coronavirus?”

As mentioned, some variations of a retrieval model may include updating content segment priority based on user affinity modeling S146, which functions to apply automated personalization of the results. User affinity modeling can generally be used to refine results so that content segments corresponding to predicted user preferences are ranked preferentially. A user affinity score of one or more candidate content segments is used, where the user affinity score corresponds to modeled preference of user or similarity between a content segment and modeled data of the user. User affinity may be determined and then used in prioritizing content in a variety of ways. In some implementations, this may function to infer context based on contextual cues of the user interactions or use of the query interface.

In some variations user affinity may be used as a ranking tool to order content segment results whereby the content segment results are ranked based in part on a user affinity scores of at least a subset of content segments. The user affinity score in some variations may be used as a secondary ranking property, but may additionally or alternatively be used as a property to filter results (e.g., exclude results not satisfying some condition based on user affinity score) and/or as a primary ranking priority.

The user affinity score may be calculated in a variety of ways.

In one variation, the user affinity score may be based on a configured user profile where content preferences are set. A profile indicating preferences may be completed by the user or generated based on analysis of user data. In one variation, the profile may indicate specific context keywords for which a user may have affinity. In one example, for querying of programming related book content within an IDE, the detected programming languages and/or technology usage within one or more code projects may be used in setting user-related context keywords for programming language and/or other technology preferences (e.g., libraries, frameworks, and/or webstacks used by a user). A user affinity score may be calculated by calculating a score based on the occurrence of user-related context keywords in the context metadata of a context segment.

In another variation, user affinity modeling may leverage using a collaborative metric learning (CML) model to map users and content (e.g., content segments, keywords of content, content sources, etc.) to shared vector space for similarity analysis. A collaborative metric learning (CML) model may be used to preferably provide an “n=1” predictive personalization that is highly responsive, and which may not depend on having large amounts of historical data relating users and content. In this way, a new user or a query session may be quickly provided with personalized search and discovery. In some variations, this may be done without user-to-user modeling and without dependence on large content/user datasets.

Use of CML model may be particularly helpful in enhancing personalization of long-form content retrieval because, in many cases, there may be low amounts of historical interaction data related to users interacting with content segments. For example, there may be no or very sparse historical interaction data that could be used to statistically predict how one or even a group of users may perceive a particular paragraph within a whole collection of books. The CML model described herein is one example of calculating user affinity that can be readily performed with such sparse data. Alternative user and content modeling may alternatively be used.

Calculating a user affinity score (used for updating content segment priority based on user affinity modeling) may include calculating a user affinity score using a system and method characterized in U.S. patent application Ser. No. 17/116,565, filed 9 Dec. 2021, and titled “SYSTEM AND METHOD FOR A PERSONALIZED SEARCH AND DISCOVERY ENGINE”, which is hereby incorporated in its entirety by this reference.

Unless pre-trained data models are previously provided, a collaborative metric learning implementation may include training a content neural network (CNN) and training a user neural network (UNN), and then applying a collaborative metric learning model (a “MatchMaker Neural Network”/CML model), which functions to train a shared embedding for processed user and content items. Herein, the output of the CML is referred to as a shared-item embedding. The CNN transforms data related to content to a content embedding. The UNN transforms data related to a user to a user embedding. The CML model is preferably used in transforming the content embedding and user embeddings from the content neural network and the user neural network respectively. The CML model is preferably applied to a content embeddings from the CNN and/or item embeddings of the UNN thereby mapping content or users to a shared embedding space. Data interpretation of user data and a content segment may be analyzed and scored based on spatial relationship (e.g., displacement condition) in multi-dimensional vector space of the shared-item embeddings.

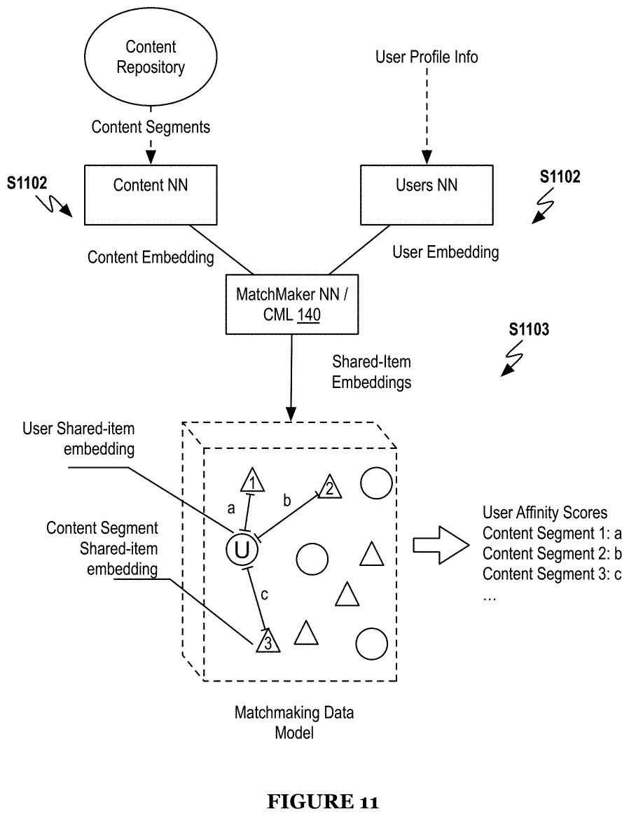

With such learning models, a user affinity score for relating a user to a content segment can translate user data and/or content data to their respective shared-item embeddings and then compared. Accordingly, S144 may include, as shown in FIG. 11: processing user data through the UNN and at least the matchmaking neural network (e.g., the CML model) in generating a user shared-item embedding S1101; processing content segment data through the CNN and the least the matchmaking neural network (e.g., the CML model) in generating a content shared-item embedding S1102; and calculating the user affinity score based on a spatial relationship of the user shared-item embedding and the content shared-item embedding S1103. Calculating the user affinity score based on spatial relationship of the user shared-item embedding and the content shared-item embedding may include calculating the displacement distance between the user shared-item embedding and the content shared-item embedding. Calculating the distance can be a Euclidean displacement between the two shared-item embeddings. This variation reflects a user affinity score based on how a user directly relates to a content segment.

This may alternatively be performed to score user affinity to the source of a content segment (e.g., scoring user affinity to each book, publication, etc.), to context keywords that may be detected in the content segment, or other constructs related to a content segment.

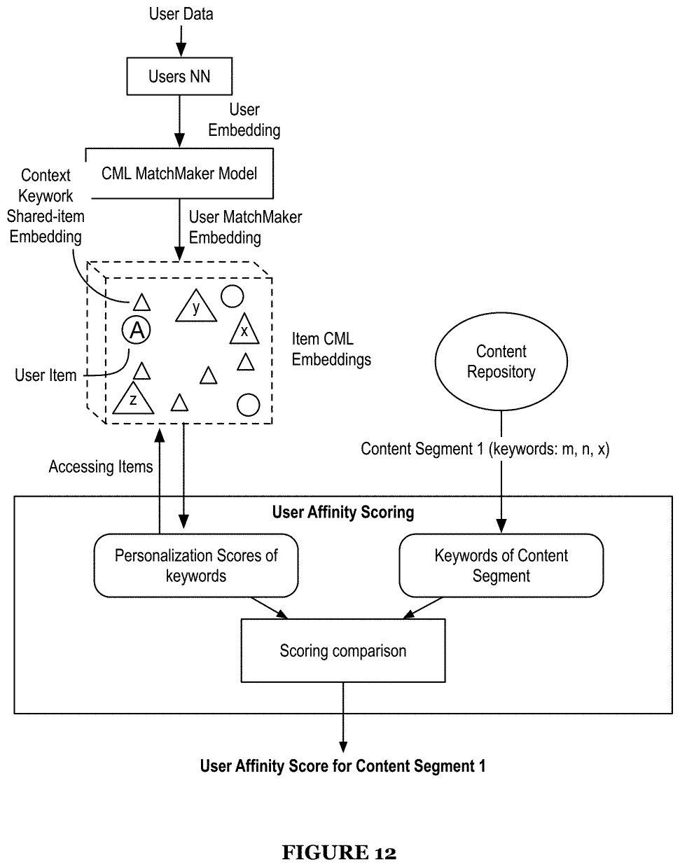

As an example of an alternative variation, user affinity score may be based on user affinity to context related keywords. In one implementation, a personalization score may be calculated for the spatial relationship of a user shared-item embedding and a shared-item embedding for one or more context keywords as shown in FIG. 12. A resulting user affinity score may then be calculated for a content segment based on personalization scores of context keywords related to the content segment. In one exemplary implementation shown in FIG. 12, a personalization score based on the CML for different keywords can be calculated for the user, and the personalization scores can be compared to the context keywords associated with a content segment to generate the user affinity score for that particular content segment. For example, context keywords concepts “Python”, “machine learning”, and “NLP” may be context keywords with high personalization scores for a user (using the CML), and then content segments that are associated with the context keywords of “Python”, “machine learning”, and “NLP” may be assigned a higher affinity score.

In such a variation, S144 may include: processing user data through the UNN and at least the matchmaking neural network (e.g., the CML model) in generating a user shared-item embedding; and calculating a personalization score between the user and context keywords based on a spatial analysis of the user shared-item embedding and other shared-item embeddings. In one implementation, in place of a content neural network, a keyword neural network may be trained and used to map context keywords to shared-item embedding vector space. In this variation, a spatial analysis of user shared-item embedding to context keyword shared-item embeddings may be used (e.g., finding n-nearest, finding distance between user and each context keyword, etc.). Alternatively, content may be mapped as described above, and then context keywords identified in content segments may be used to calculated personalization scores to different context keywords for a user.

A user affinity score may be used as a secondary ranking property, which can be used to disambiguate ranking of similarly ranked candidate content segment results. In one exemplary implementation it may be used break ranking ties after ranking with the query-content model. Accordingly, S144 may include calculating a query-content model score for each content segment of the initial set of candidate content segments and ranking the initial set of candidate content segments by query-content model scores; and, for each subset of candidate content segments with query-content model scores satisfying a tie scenario condition, ordering content segment results within each subset of candidate content segments by the user affinity scores.

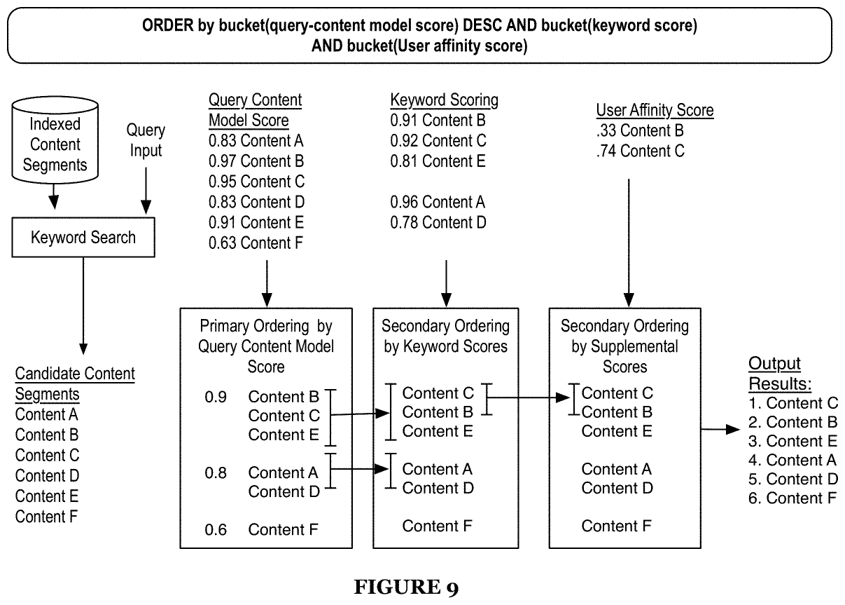

In a similar variation, user affinity may be used as a secondary ranking property after ranking by keyword search scores. Accordingly, S144 may include calculating a query-content model score for each content segment of the initial set of candidate content segments and ranking the initial set of candidate content segments by query-content model scores; for each subset of query-content model scores satisfying a tie scenario condition, ordering content segment results of each subset of by a keyword search score (e.g., TF-IDF score); and, for each subset of keyword search scores satisfying a tie scenario condition, ordering content segment results of each subset by the user affinity scores as shown in FIG. 9.

A user affinity score may alternatively be used as a primary ranking property. In one exemplary implementation, S144 may include ranking the initial set of candidate content segments by user affinity scores, and, for each subset of user affinity scores satisfying a tie scenario condition, ordering content segment results of each subset of by a query-content model score (e.g., BERT score). Such an exemplary implementation may further resolve ranking whereby, for each subset of query-content model scores satisfying a tie scenario condition, ordering content segment results of each subset of by a keyword search score (e.g., TF-IDF score). Other alternative ranking ordering and combinations may alternatively be used.

User affinity may be characterized as an assessment to how content (or another construct like a keyword) relates to a user. The scope of this “affinity” may be implementation dependent. In some implementations user affinity may describe how a user's full history of interactions with a digital system relate to the content. User affinity may alternatively describe affinity of a user within an alternative scope.

Some implementations may allow the affinity scope to be based on other conditions. In some cases, the scope may be more limited. In some variations, user affinity may be scoped to score the “affinity” and correspondence of content and a user for a particular usage session. In one example, the user affinity scope may be tied to temporally proximate queries for example queries happening together as part of some “objective”. For example, the method may include setting contextual user affinity when a user begins on using a query interface after having not used the query interface for some preset amount of time (e.g., five days). In a similar way, interactions and data informing the user affinity may be expired after some amount of time so that the user affinity lacks long historical bias. In a similar way, interactions and events informing user affinity may be near-term biased which functions to emphasize recent indications of interest over those from longer ago.

In one variation, the user affinity scope may be exposed and selectable through the user interface. For example, a user searching for a solution to some software-related issue may create a new search scope so that all queries made associated with that search scope are personalized to those. Then that user may create a new search scope for a different set of queries so that those queries are personalized within that different context.

In other variations, the user affinity scope may dynamically change based on detected changes in context. In a customer service example, the user affinity scope may be changed for each new customer that calls an agent. In this way, the method may include detecting a change in associated user, enabling the customer service agent to effectively serve as a proxy for the user to be able to see potential answers to their questions and apply their own expert judgement in what they relay to the user.

The method may additionally include applying personalization, which may allow use of previous interaction signals. Interactions signals may include queries; content interactions like clicking, bookmarking, liking, or commenting; and/or other suitable activity may be used in signaling relevance. In some instances, one or more of such signals may be used in calculating user affinity scores.

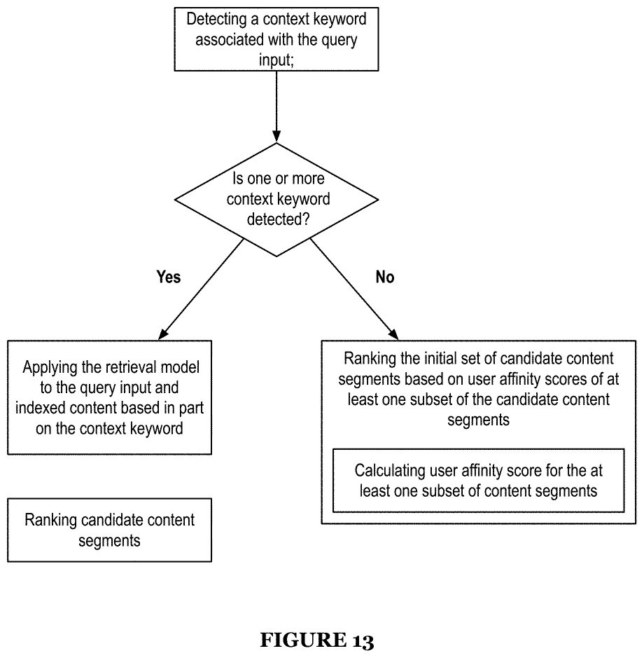

In some implementations, user affinity may be used to enhance contextual relevance of results. In this variation, user affinity scores may be selectively invoked if a contextual keyword is not associated with a query input. Accordingly, a variation of S143 may include detecting a context keyword associated with the query input; if one or more context keyword is detected, applying the retrieval model to the query input and indexed content based in part on the context keyword; and if a context keyword is not detected ranking the initial set of candidate content segments based, at least in part, on user affinity scores of a subset of the candidate content segments as shown in FIG. 13. Herein, contextual keywords may include particular keywords that can indicate context and/or scope of a query. For example, in the query “how to sort a list in python”, python could be used a contextual keyword as it scopes intended results to those that relate to python.

Context keywords may be a pre-defined list or automatically generated list. In one variation, the method can include generating a list of context keywords which functions to mine relevant contextual keywords that may be used within collection of media content. Generating the list of context keywords can include identifying high frequency terms (or related terms) in (high frequency. For example, in a programming question-answer implementation, various programming languages or system names may be detected as context indicators. The list of context keywords may alternatively be extracted from category metadata, labels, tags, and/or other classifying data identified in source content. The context keywords may alternatively be generated or formed in any suitable manner. In some variations, the context keywords may have hierarchy or relationships to other context keywords. The context keywords may additionally have different priorities or scores such that certain context keywords may be more highly weighted than others.

Detecting a context keyword associated with a query input functions to identify a key concept relate to the query input This may include detecting the contextual keyword present in the query input. This may additionally or alternatively include detecting a contextual keyword being associated with the query input (e.g., stored in a user profile of the user making the request, usage of the contextual keyword in past queries, interaction of the user with previous results associated with the contextual keyword).

In query instances where there is no context (in the query input or from supplementary attributes of the query or use of the query interface), then user affinity-based ranking may be automatically selected and used to (at least partially) prioritize content segments based on expected context as shown in FIG. 13. This functions to leverage modeled or tracked user affinity to certain context keywords to be used to filter, sort, and/or otherwise alter the content segment results. For example, a user may submit a query of “how to sort a list” to a programming question-answer implementation. There will be many suitable content segments that could satisfy this query for various programming languages and different contexts. User affinity to a particular programming language, such as Python, may however be used to properly select and/or prioritize content segments that answer the question of how to sort a list in the programming language for which the user has highest affinity. The various approaches to calculating an affinity score as described above may be used.

In some query instances, context keywords may be detected in the query input and/or associated with the query input. In some variations, user affinity may not be used in sorting, filtering, or ranking content segments for such a query instance. The detected context keyword may be specifically used in augmenting the determination of the candidate content segment results. Accordingly, a query input for “how to sort a list in python” will extract python as a context keyword and use that at least in part to sort, prioritize, filter, and/or determine results. In the case where a context keyword is identified in a query input (explicit), it may be used to over-rule user affinity context (implicit). In other implementations, detected context keywords may be used in combination with affinity scores.

In one variation, if a context keyword is associated with an instance of a query input, retrieving the initial set of candidate content segments performing a keyword search includes retrieving the initial set of candidate content segments by performing a keyword search filtered by the context keyword. For example, a keyword search could be performed for “how to sort a list in python” where the context keyword “Python” is required to be associated with each candidate content segment. The results would thereby be limited to those relating in some way to “Python”. If multiple context keywords are associated with a query input, then all or at least a subset of the context keywords may be required. This variation uses context keywords to filter results.

In another variation, if a context keyword is associated with an instance of a query input, ranking the initial set of candidate content segments can be at least partially based on association with the context keywords. In this variation, context keywords may be used to at least partially rank initial set of content segment results. Using the above example, the initial set of candidate content segments may have the candidate content segments ranked accordingly if they are associated with the context keyword python. So, for example, all content segments that relate to the python keyword will be prioritized above those that do not. If multiple context keywords, then those context keywords can similarly be used.

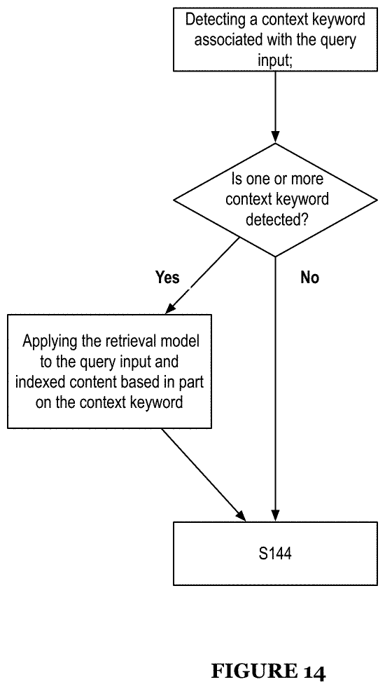

In some variations, applying the retrieval model may use explicit context keywords independent of user affinity modeling. As shown in FIG. 14, a variation of the method may include detecting a context keyword associated with the query input; if one or more context keyword is detected, applying the retrieval model to the query input and indexed content based in part on the context keyword.

Some variations may additionally include incorporating supplemental content signals S148, which functions to use other supplementary signals to refine prioritization and ranking. Additional content signals may be used conditionally to differentiate or determine priority from content segments with similar keyword scores, query-content language model scores, and/or user affinity scores. Supplementary content signals may include signals such as popularity metrics for a piece of content. In one variation, supplementary content signals such as click/read/view count, upvote count, comments, reviews, sharing information, citations (e.g., peer review citation count), social media metrics or signals, search-like scoring (e.g., Page Rank), and/or other metrics may be used to prioritize one content segment over another content segment. Such supplemental content signals may be used for resolving various tie scenario conditions. The retrieval model may apply these various processes conditionally based on the results of previous retrieval process. One or more of such content signals may be used to disambiguate and rerank items that satisfy tie scenario conditions as discussed below.

The above scoring and evaluation processes can preferably be used in a variety of combinations or sequences during application of the retrieval model. The keyword search (e.g., TF-IDF or alternative general fast search process) is preferably used to obtain initial results, but then some sequence and/or combination of the scoring models can be used to determine order/priority of content segments. In a preferred variation, the query-content model is used to do a first pass of ordering, and then subsequent scoring models and/or other signals can be used to refine. Refinement of the ranking is preferably used when ranking of two or more content segments satisfy a tie scenario condition.

In one variation, the query-content model scores may be generated for each result of the keyword search and then used to do an initial interim ranking. This interim ranking may then be partially reranked for subsets of the content segments satisfying a tie scenario condition. In another variation, the query-content model score may be used in tie scenario of a preceding process like evaluation of the keyword search score.

A “tie” scenario may characterize a condition where scores are evaluated and determined to be within a preset threshold of closeness (e.g., equal and/or within 5% of each other). For example, if the query content model scores are used as a secondary ranking property to resolve a tie scenario condition, the query content model scores of subsets of content segments in a tie scenario can be used to determine the ranking within that subset. This may be performed multiple times for multiple content segments that have “tie” scenarios as shown in the examples of FIGS. 7-10.

In one variation, the keyword search score may be used if there is a tie scenario from the query-content model.

The user affinity scores may be used to further refine the order by resolving tie scenario conditions. In one variation, if the retrieval scores from keyword search and the query-content models satisfy a “tie” scenario condition (e.g., same score or within some closeness range like 5%), then the user affinity scores may be used to differentiate. In other variations, user affinity may be used as a ranking process with higher priority than the query-content model. In another variation, user affinity may be used conditionally if a context keyword is not present.

The supplemental content signals can similarly be used to revolve tie scenarios in combination or as a fallback tie-breaking process if a tie scenario exists after some combination of keyword, query-content model, and/or user affinity scores are used.

As a first example shown in FIG. 2, the retrieval model may work by calculating the query-content model score (e.g., retrained BERT score) for each content segment retrieved through the keyword search; for any subsets of query-content model scores satisfying a tie scenario condition, calculating the keyword search score (e.g., TF-IDF score); and for any subsets of the keyword scores satisfying a tie scenario using one or more supplemental content signals scores. Such tie-breaking ranking process is similarly reflected in the example of FIG. 8.

These scores are used to rerank subsets of content segments. Accordingly, this may be more specifically described as: calculating the query-content model score (e.g., retrained BERT score) for each content segment retrieved through the keyword search and generating a first interim ranking of the content segments; within each subset of content segments with query-content model scores satisfying a tie scenario condition, calculating the keyword search score (e.g., TF-IDF score) and reranking using the keyword search score (e.g., reranking within the subset of content segments with query content model scores satisfying a tie condition); and within each subset of content segments with TF-IDF scores satisfying a tie scenario, reranking using the one or more content signal scores (e.g., reranking within the subset of content segments with TF-IDF scores satisfying a tie scenario).

The resulting priority after these score calculations is then used in determining which content segments to present and their priority, in terms of their relative ranking for users.

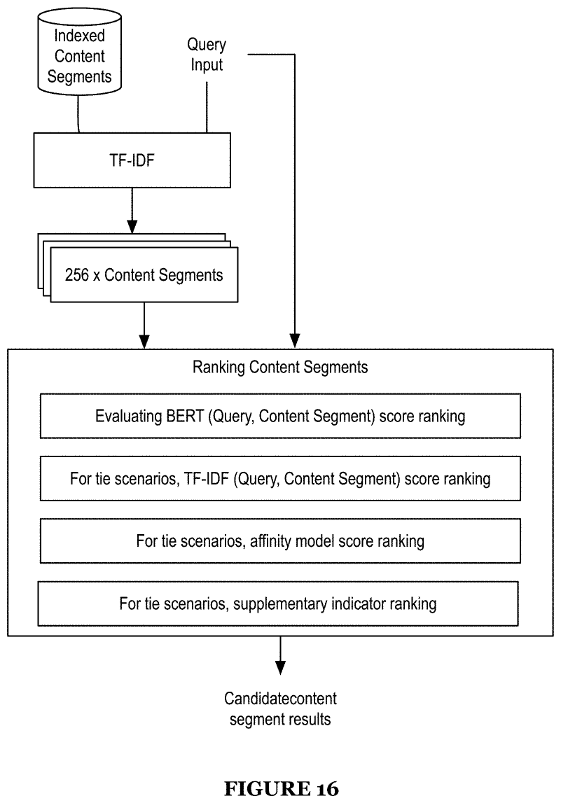

As another example using user affinity shown in FIG. 16, the retrieval model may work by calculating the query-content model score (e.g., retrained BERT score) for each content segment retrieved through the keyword search; for any subsets of query-content model scores satisfying a tie scenario condition, calculating the keyword search score (e.g., TF-IDF score); for any subsets of the keyword search scores satisfying a tie scenario condition, calculating a user affinity score; for any subsets of the user affinity scores satisfying a tie scenario using one or more supplemental content signals scores. Similar to above, these scores are used to rerank subsets of content segments as shown in the exemplary scenario of FIG. 9.

This may be more specifically described as: calculating the query-content model score (e.g., retrained BERT score) for each content segment retrieved through the keyword search and generating a first interim ranking of the content segments; within each subset of content segments with query-content model scores satisfying a tie scenario condition, calculating the keyword search score (e.g., TF-IDF score) and reranking using the keyword search score (e.g., reranking within the subset of content segments with query content model scores satisfying a tie condition); within each subset of content segments with keyword search scores satisfying a tie scenario condition, calculating a user affinity score and reranking using the user affinity score (e.g., ranking within a subset of content segments with TF-IDF scores satisfying a tie scenario); and within each subset of content segments with user affinity scores satisfying a tie scenario, reranking using the user affinity scores (e.g., reranking within the subset of content segments with user affinity scores satisfying a tie scenario).

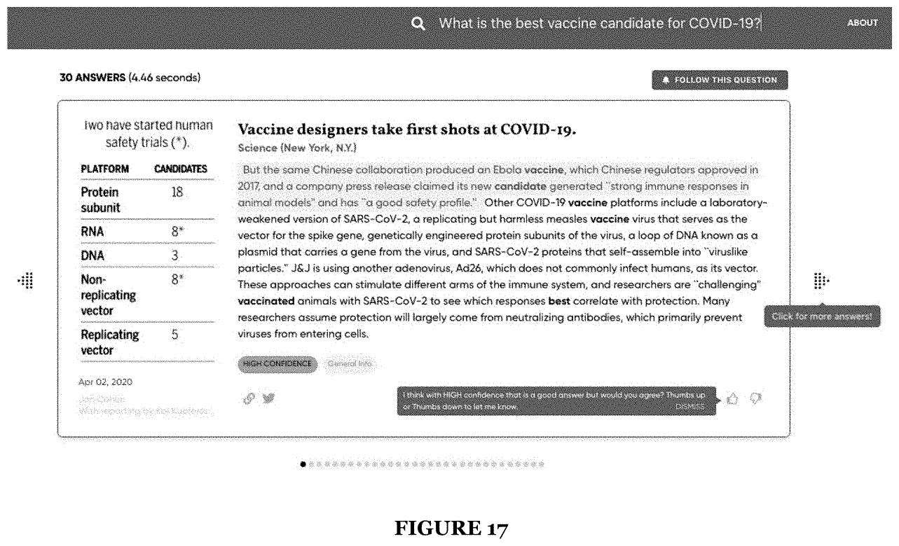

Block S150, which includes presenting the candidate content segment results, functions to present the content segments. The content segments are preferably displayed or otherwise presented in a user interface tied to the query interface. In general, this interface may be a graphical user interface and so a visual representation of one, a subset, or each of the content segment results can be displayed as shown in FIG. 17. The content segments are preferably presented according to their priority determined by the retrieval model. Priority is preferably used for determining order, but it may additionally determine how they are presented. For example, higher priority content segments may have more of their content presented while lower priority content segments may have more condensed summaries displayed.

The method may additionally or alternatively include otherwise applying the candidate content segment results. Applying the candidate content segment results may use the results for some alternative action. In a programming use case, the generated content segment may be used in augmenting code autocompletion of a programming environment. In a customer care scenario, a content segment may be used in determining some action performed by the system of the customer care representative. For example, if the search for a solution to a customer's problems with their internet service identifies some action like performing an automated connection test as the likely solution, then that may be automatically initiated. Any suitable automated system may be built around leveraging the solution identification capabilities of the method.

In the case of query-retrieval user interface used for interacting with a library of text-based documents (e.g., books), the method may include consolidating content segment results. This may be performed to limit the number of results from a single source. In this way the user interface may consolidate presentation of content segments from the same source into a unified user interface element. In general, lower ranked content segments are incorporated or referenced within a higher ranked content segment. For example, the top content segment from a book may be presented with a small reference to other content segments from the book that were also related. This may allow for easier digital browsing within a reference with relevant results.

In the case of query-retrieval user interface used for interacting with a collection of recorded media (e.g., videos and/or audio recordings) the method may, in a similar manner, render a media presentation interface for consolidated consumption of content segments. This consolidated consumption may splice different content segments into one media presentation. This could be performed within one recorded media source or across sources. In one example, all the relevant snippets of a video of a lecture could be listened in succession.

In some variations, interactions with the user interface presenting the content segment results may be monitored and used in augmenting subsequent query inputs.

### 3. System

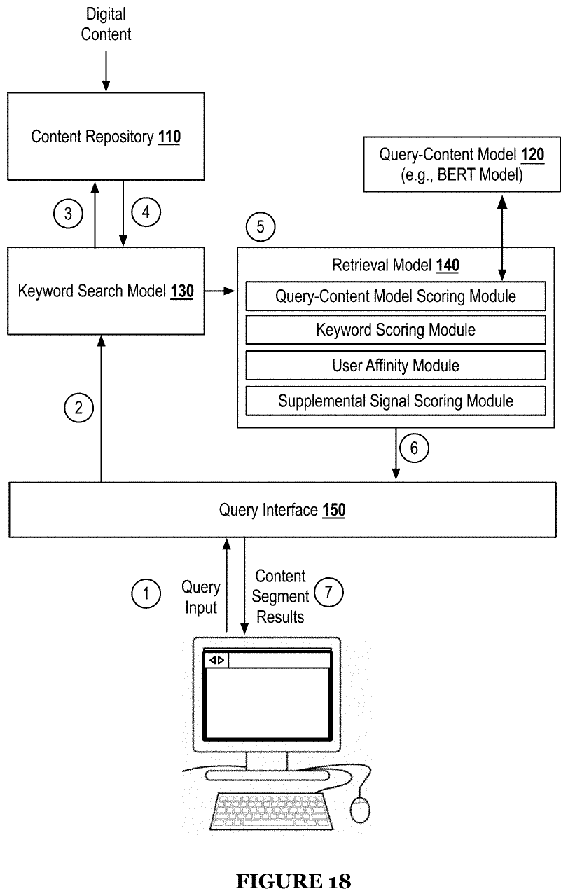

As shown in FIG. 18, a system for question-based content searching of a preferred embodiment preferably includes access to a content repository no; a query-content model 120; a keyword search model 130; a retrieval model 140 that leverages some combination of the scores from the query-content model, keyword search model, a user affinity model and/or supplemental signals; and a query interface 150.

The content repository 110 functions to store content data for the system. As discussed, the system can be used with a wide variety of types of content from which content segments can be extracted. Books, articles, papers, and/or other types of long-form content may particularly benefit from system as they are not originally intended for addressing specific queries. The content repository no is preferably digitally stored, indexed, and made accessible by a computer-implemented data system of the system.

The content repository no may contain data that has been, or will be, analyzed by the system. The content repository no may interface with one or more external data sources. The content repository no or the system in general may include one or more computer executed services that can facilitate interfacing with a data source. In some variations, the content repository 110 may be populated from data from a data source looking to make use of the system. Alternatively or additionally, data of the content repository 110 may be populated in part from actively retrieving the data from one or more external data sources (such as through crawling a site).

Such services may include services for interfacing through an application programming interface (API) and/or crawling. In one example, a web scraper can be used in obtaining data from the internet or a particular source. Additionally or alternatively, the content repository 110 may have a collection of data directly loaded into the content repository no. As another variation, data may be loaded using an external content/user data service, a direct integration with a website's content management system (CMS), or another form of data integration. The content repository 110 of may alternatively obtain data through any suitable approach.

The query-content model 120 preferably functions to signal the degree a query corresponds to a piece of content. The query-content model is preferably a language model that with some level of training for a similar domain as the content repository no. For example, for example, BERT language model may be retrained on a large collection of medical question answer information.

The keyword search model 130 functions to quickly find an initial set of content segments for deeper evaluation and/or possibly for determining priority. The keyword search model 130 may use TF-IDF but any suitable general search algorithm may additionally or alternatively be used.

The retrieval model 140 functions to identify and rank content segments from the content corpus in response to query input from the query interface. The retrieval model 140 may use a combination of the models described herein to evaluate and rank the content segments. The retrieval model 140 may a specially configured processing pipeline in a computer system that applies some variation of a retrieval model 140 such as described above. In different variations, the retrieval model 140 may include or operate in connection with a query-content model scoring module, a keyword scoring module, a user affinity scoring module, a supplemental signal scoring module.

The query interface 150 functions as the interface through which a query input is received. The query interface 150 can be a user interface wherein query input is collected from a user. The query interface 150 may alternatively be a programmatic interface (e.g., an API) wherein the query may be received, extracted, generated, and/or otherwise obtained from a communicatively coupled computer system. The query input is preferably supplied as textual input. However, in some cases image, audio, and/or other media medium formats may be used. A query response is preferably supplied in connection with the query interface. The query response will preferably include the ranked list of top content segments identified by the retrieval model.

The query interface 150 may additionally be or operate in cooperation with the interface through which the content segment results are presented.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., non-transitory computer-readable medium) storing instructions that, when executed by the one or more computer processors, cause a computing platform to perform operations comprising those of the system or method described herein such as: training a query-content model, indexing content, receiving a query input, applying a retrieval model to query input and indexed content in determining candidate segment results, and presenting the candidate segment results.

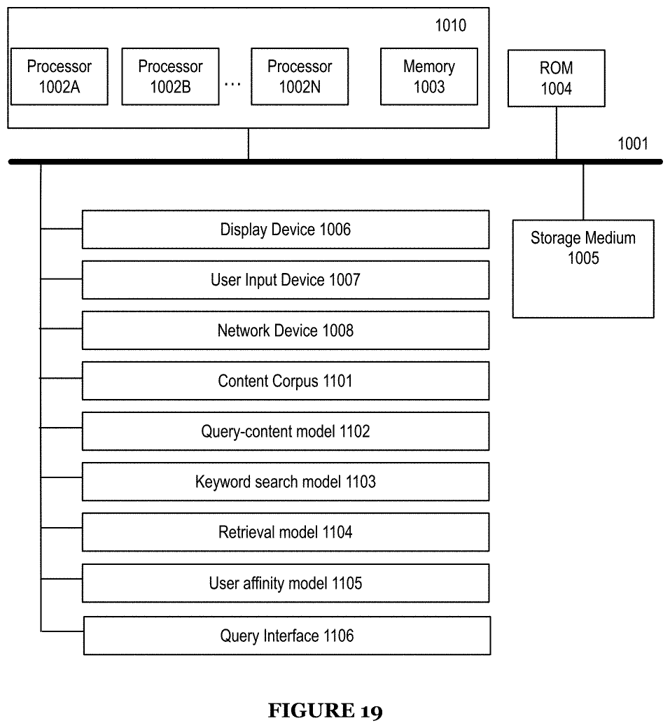

FIG. 19 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random-access memory (RAM)) 1003, a read only memory (ROM) 1004, a processor-readable storage medium 1005, a display device 1006, a user input device 1007, and a network device 1008. As shown, the computer infrastructure may be used in connecting a content corpus 1101, a query-content model 1102, a keyword search model 1103, a retrieval model 1104, a user affinity model 1105, a query interface 1106, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
training a query-content model;
indexing a collection of media content data forming indexed content;
receiving a query input through a computer implemented computer interface;
applying a retrieval model to the query input and indexed content and determining candidate content segment results, which comprises:
retrieving an initial set of candidate content segments by performing a keyword search of the query input on the indexed content, and
ranking, based in part on language modeling using the query-content model, the initial set of candidate content segments into the candidate content segment results; and
presenting the candidate content segment results in the computer interface.

2. The method of claim 1, wherein training the query-content model comprises training the query-content model using bidirectional encoder representations from transformers language model on a set of question-answer pairs stored in a data system; and ranking, based in part on language modeling using the query content model, the initial set of candidate content segments comprises calculating a query-content model score for each content segment of the initial set of candidate content segments.

3. The method of claim 2, wherein the bidirectional encoder representations from transformers language model has a model architecture with at least 50 million parameters.

4. The method of claim 2, wherein retrieving an initial set of candidate content segments by performing a keyword search of the query input on the indexed content comprises performing term frequency-inverse document frequency processing when retrieving the initial set of candidate content segments.

5. The method of claim 2, for each subset of candidate content segments with query-content model scores satisfying a tie scenario condition, ordering content segment results within each subset of candidate content segments by a keyword search score.

6. The method of claim 5, for each second subset of candidate content segments with keyword search scores satisfying a tie scenario condition, ordering content segment results within each second subset of candidate content segments by a user affinity score.

7. The method of claim 6, wherein ordering content segment results within each second subset of candidate content segments by a user affinity score comprises, with the second subset of candidate content segments, initially calculating, based on a collaborative metric learning model, a user affinity score between a candidate content segment of the second subset and user data associated with the query input.

8. The method of claim 1, wherein applying a retrieval model to the query input and indexed content further comprises: detecting a context keyword associated with the query input; if one or more context keyword is detected, applying the retrieval model to the query input and indexed content based in part on the context keyword.

9. The method of claim 1, wherein applying a retrieval model to the query input and indexed content further comprises: detecting a context keyword associated with the query input; if one or more context keyword is detected, applying the retrieval model to the query input and indexed content based in part on the context keyword; and if a context keyword is not detected ranking the initial set of candidate content segments based, at least in part, on user affinity scores of a subset of the candidate content segments.

10. The method of claim 1, wherein the collection of media content data comprises text-based documents.

11. The method of claim 10, wherein the text-based documents are electronic books.

12. The method of claim 10, wherein indexing the collection of media content data comprises parsing and segmenting the text-based documents into paragraph content segments with context data that includes document title, section headers, and adjacent paragraphs.

13. The method of claim 1, wherein the collection of media content data comprises recorded media recording data files.

14. The method of claim 12, wherein recorded media recording data files comprises video data files and audio data files.

15. The method of claim 12, wherein indexing the collection of media content data comprises segmenting the media recording data files based on an audio transcription.

16. The method of claim 1, wherein the computer interface is a graphical user interface.

17. The method of claim 1, wherein the computer interface is an application programming interface.

18. A non-transitory computer-readable medium storing instructions that, when executed by one or more computer processors of a computing platform, cause the computing platform to perform the operations comprising:
training a query-content model;
indexing a collection of media content data forming indexed content;
receiving a query input through a computer implemented computer interface;
applying a retrieval model to the query input and indexed content and determining candidate content segment results, which comprises:
retrieving an initial set of candidate content segments by performing a keyword search of the query input on the indexed content, and
ranking, based in part on language modeling using the query-content model, the initial set of candidate content segments into the candidate content segment results; and
presenting the candidate content segment results in the computer interface.

19. A system comprising:
one or more computer-readable mediums storing instructions that, when executed by the one or more computer processors, cause a computing platform to perform operations comprising:
training a query-content model;
indexing a collection of media content data forming indexed content;
receiving a query input through a computer implemented computer interface;
applying a retrieval model to the query input and indexed content and determining candidate content segment results, which comprises:
retrieving an initial set of candidate content segments by performing a keyword search of the query input on the indexed content, and
ranking, based in part on language modeling using the query-content model, the initial set of candidate content segments into the candidate content segment results; and
presenting the candidate content segment results in the computer interface.
